(19) United States
(12) Patent Application Publication
(10) Pub. No.: US 2009/0068310 A1
(43) Pub. Date: Mar. 12, 2009

(54) Dairy products and dairy product analogues and method of preparing same

(76) Inventors: Arjen Bot, AT Vlaardingen (NL); Jan Willem Sanders, At Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/920,213

(22) PCT Filed: Apr. 24, 2006
(86) PCT No.: PCT/EP2006/003914

§ 371 Date: Sep. 4, 2008

(30) Foreign Application Priority Data
May 11, 2005 (EP) 05076103.0

(51) Int. Cl. A23C 9/13

(52) U.S. Cl. 426/39; 426/43; 426/41; 426/580

(57) ABSTRACT

A method of preparing a dairy product or a dairy product analogue, the dairy product or dairy product analogue comprising a sterol, wherein the method comprises acid coagulating a cheese milk, cream or combination thereof in the presence of a suitable culture and subsequently subjecting to a heat treatment, the culture comprising an exopolysaccharide producing lactic acid bacterium.

The invention relates to dairy products and dairy product analogues and a method for their preparation.

For the purpose of this invention, dairy products are products comprising acidified milk based products. Dairy products are generally made from a suitable mixture of concentrated milk protein and fat sources, which are acidified and further processed with optional whey separation. Dairy products include yoghurts, ice-cream and dairy spreads such as spreadable fresh cheese, cottage cheese, quark, crème fraîche, clotted cream and cream cheese.

For the purpose of this invention, dairy product analogues are products made in a similar way to the dairy products above, but where (fully or partly) a non-milk source of protein is used and/or (fully or partly) a non-dairy source of edible fat. Suitable protein sources include vegetable proteins such as soy, potato and pea. Suitable fat sources include oils and fats from vegetable or marine origin. In this application fats and oils are used as interchangeable terms. Similar preparation as referred to above are meant to include processes for products in which a traditional whey separation step is omitted because the formulation of the dairy analogue of the product allows skipping this step.

It is known in dairy products such as those described above to include sterols, particularly when it is desirable for the products to have improved nutritional properties, for example when a hypocholesterolemic effect is required. Many dairy products containing sterols have been disclosed, for example WO-A-99/44442 discloses the use of phytosterols and their derivatives in products having a reduced fat content.

It is known that products containing two immiscible phases may suffer from creaming of the less dense phase, either during the process or during storage. The standard solution in emulsions is to reduce droplet size of the dispersed phase, and/or to increase the viscosity of the continuous phase. In acidified dairy products the continuous phase is often the aqueous phase and the dispersed phase in such products is the fat phase.

Droplet size can be easily adjusted through the addition of specific efficient emulsifiers (e.g. proteins or low molecular weight emulsifiers), or by increasing the intensity of the dispersion process (e.g. a higher homogenisation pressure).

The viscosity of the continuous phase can be increased through the addition of a stabiliser or thickener. For example, WO-A-99/44442 employs substances such as xanthan gum, carrageenans, pectins, starch, gellan gum or cellulose in order to provide a stabilising effect. However, it is sometimes undesirable from a marketing point of view to extend the ingredient declaration list for the product with additional viscosity modifiers to achieve this effect, especially for products with a healthy image. Furthermore the inclusion of a large amount of stabiliser or thickener may negatively influence the mouthfeel of products

It has now been surprisingly found that sterol-containing dairy products, and sterol-containing dairy product analogues can be stabilised and simultaneously thickened through fermentation using specific exopolysaccharide producing lactic acid bacteria, resulting in a product having an increased viscosity. When used instead of thickener/stabiliser there is no additional legal requirements to extend the ingredient declaration list. Neither do the resulting products suffer from a deterioration in mouthfeel. The stabilising action in sterol-containing products is more efficient than in regular products without sterols because it was surprisingly found that the density difference between the dispersed and continuous phase in sterol-containing products is less than in products based on a normal predominantly triglyceride-based dispersed phase. The stabilising effect is most pronounced in systems containing a dispersed phase based on pure sterols and not containing triglycerides or only a very low amount of triglycerides. The beneficial stabilising effect may occur either during processing or in the end-product.

The general incorporation of bacteria in food products, and in particular dairy products, has been described in the literature.

For instance EP-A-111,020 describes the use of a specific combination of bacteria to produce a thick fermented milk product.

EP-A-639,332 describes a method for the manufacture of reduced fat cheddar cheese. A culture system is used comprising a ropy culture. In the process of preparing the cheddar, cheese milk is acidified by a starter culture for 30 minutes and subsequently ripened for 30 minutes in the presence of rennet.

EP-A-196,436 describes the use of a mixture of various Streptococcus Cremoris bacteria in the manufacture of quark. No heat treatment or homogenisation step is applied to the quark mix.

EP-A-331,564 describes the use of a polysaccharide from a specific Streptococcus thermophilus culture as a thickener for example for the production of yoghurt.

U.S. Pat. No. 4,243,684 aims to reduce the sandiness in soft cheese such as Camembert, Brie, Romadur, Limburger and Muenster by using specific ropy cultures. In these products, coagulation is primarily effected by the action of rennet. No heat treatment is applied after coagulation.

WO-A-94/12656 describes specific Lactobacillus sake strains which have the capability of producing exopolysaccharides in products such as margarines and dressings.

FR-A-2,154,371 relates to fresh cheese products such as yoghurt that are acidified to a certain pH and subsequently consumed. As said products are not heat-treated after coagulation, said products highly likely comprise living, active lactic acid bacteria.

WO-A-92/02142 discloses novel donor bacteria harbouring a plasmid DNA fragment, encoding for a substance that increases viscosity of a milk-containing product. Said bacteria may be used for the production of buttermilk, sour cream and cottage cheese. Said products are believed to comprise live bacteria as no heat treatment is applied after acidification.

EP-A-82581 relates to fermented milk products, e.g. yoghurt, comprising specific lactic acid bacteria, interconnected by threads of biopolymers. Said products are allowed to ferment and the resulting product is then ready for consumption.

Sebastiani, H (DMZ Lebensmittel Industrie und Milchwissenschaft, vol. 115, no. 12, 9 Jun. 1994, page 586) discloses the use of Streptococcus thermophilus strains in the production of exopolysaccharides. Said strains are said to be applicable for fermentation of acidified milk products and soft cheese.

Obert, G (Magyar Tejgazdasag Kiserleti Intezet, Pecs, Hungary. Tejipar. Vol. 33, No. 2, p. 47-48, 1984) discloses the preparation of a cream turo by using a heat resistant, slime producing strain of Streptococcus thermophilus which allegedly improves rheological properties. Said products are packaged at 60° C., without killing said slime producing bacteria.

In none of the above cases has the specific problem of the increasing viscosity of products containing sterols using natural viscosity modifiers been discussed.

### SUMMARY OF THE INVENTION

Surprisingly, it has now been found that specific exopolysaccharide producing lactic acid bacteria can advantageously be used to increase the viscosity of dairy products and dairy product analogues, containing sterols.

Accordingly, in a first aspect, the invention relates to a method of preparing a dairy product or a dairy product analogue, the dairy product or dairy product analogue comprising sterols, which method comprises acid coagulating a protein source in the presence of a suitable acidifying culture capable of producing exopolysaccharides.

The invention also provides a food product comprising a dairy product or a dairy product analogue prepared according to the process defined above, as well as the use of said dairy product or dairy product analogue in the manufacture of a food product.

There is also provided the use of an exopolysaccharide producing lactic acid bacterium to increase the viscosity of a dairy product or a dairy product analogue comprising a sterol.

### DETAILED DESCRIPTION

The various aspects of the invention will now be described in more detail. In the method of the invention, the acid coagulation can optionally be followed by a heat treatment and/or whey removal and/or homogenisation, in any order.

The protein source will be chosen according to the desired dairy product or dairy product analogue. In a preferred embodiment, the protein source is derived from milk, with cheese milk, cream or combination thereof being especially preferred. Note that protein sources that are low on carbohydrates may require supplementation of the recipe with additional lactose or other sugars suitable for fermentation.

An exemplary method for the production of a dairy product is as follows. Milk or cream is standardised to the desired fat and protein content and is acidified, e.g. by means of a starter culture and optionally heated. When the pH approaches the isoelectric point of casein (about 4.6), protein coagulates, whereby the product is formed. Whey removal and homogenisation during or after coagulation are optional processing steps.

Fat may be added at any moment in the process. (Part of) the fat in the dairy product may be added after acidification. It is preferred that the process comprises a homogenisation step after the fat has been added.

In a preferred embodiment, the majority of the fat is added before acidification.

Optionally further ingredients may be included at an appropriate stage e.g. butter, cream, herbs, spices, salt, fruit preparations, binding and/or structuring agents.

If coagulation is caused to occur by the combined action of acid and heat, the pH at coagulation can be substantially higher than 4.6.

The method of the present invention can be used in the production of fresh cheese. Fresh cheese is distinguished from other cheeses in that coagulation of milk proteins is caused to occur by the action of acid e.g. formed by a starter culture, and optionally also heat, rather than by an enzyme such as rennet, and in that the fresh cheese is not matured but is ready for consumption once the manufacturing operations are complete. In the preparation of fresh cheese rennet may be employed, but in relatively small amounts as an auxiliary ingredient with respect to acidifying ingredients. In this role it is believed to serve for improving the resulting product properties and improving the efficiency of the coagulation process. The primary factor causing coagulation however is acid optionally in combination with heat.

In the case of the production of fresh cheese, generally whey is removed after coagulation and subsequent to, during, or before whey removal, a heating and or homogenisation step may be included.

After the manufacture of a dairy product, it is usually hot or cold filled into moulds or packages, allowed to cool down and stored at chill temperatures. If required, the dairy product can be removed from the moulds or package after sufficient rigidity is obtained by cooling.

Generally heating may for example be applied to lengthen the shelf-life of the products by inactivating lactic acid bacteria, which otherwise would cause further acidification of the products during subsequent storage. For the purpose of the invention, a heat treatment is defined as heating the dairy spread to a temperature above 58° for a period of more than 1 second or any equivalent temperature-time profile.

The culture suitable for use in the methods, products and uses of the invention comprises an exopolysaccharide (EPS) producing lactic acid bacterium which is capable of increasing the viscosity of a dairy product or a dairy product analogue, the dairy product or dairy product analogue containing a sterol. The EPS producing bacteria may form part of the starter cultures present, and it is preferred that they are at least a significant part of the starter culture. Other cultures may be added to the EPS bacteria, for example to increase the acidification rate of the dairy spread mixture, to contribute to the final taste of the product, or to improve the mouthfeel of the product.

Applicants have found that particularly suitable EPS producing cultures for use in the present invention are Lactobacillus delbrueckii supsp. bulgaricus 291 and Lactobacillus helveticus NCDO 766.

However, given the above guidelines, the applicants believe it well within the ability of the skilled person to identify further suitable cultures. Preferred cultures are those that produce negatively charged EPS. Preferably the dairy product or dairy product analogue has a viscosity of at least 1 Pa·s at a temperature of about 5° C. from 1 to 10 Pa·s at a temperature of about 5° C., more preferred from 2 to 6 Pa·s at a temperature of about 5° C., even more preferred from 2 to 5 Pa·s at a temperature of about 5° C. These viscosity measurements are carried at a low shear of e.g. from 0.1 to 10 s⁻¹.

For the purpose of the invention, where ranges are included saying “from (a) to (b)” it is meant to say from and including (a) up to and including (b).

Preferably the final dairy product or dairy product analogue has a dry matter content of from 5 to 70 wt %, more preferably from 10 to 65 wt %.

The fat content of the dairy product or dairy product analogue is preferably from 0.01 to 60 wt %, more preferably from 0.01 to 40 wt % fat, even more preferred from 0.1 to 10 wt %.

Particularly good product improvements are obtained with from 0 to 40 wt % fat and a dry matter content of from 10 to 65 wt %, in combination with a process that includes a homogenisation step.

Although it is highly preferred to produce an increased viscosity product by using suitable EPS-producing lactic acid bacteria only, it is possible to include other ingredients such as binding and/or structuring and/or stabilising agent, preferably in an amount of from 0.1 to 3 wt %, more preferred from 0.3 to 1.5 wt %. Preferred binding or structuring or stabilising agents are whey protein, preferably incorporated in the form of whey protein concentrate, locust bean gum, carboxymethyl cellulose, gelatine and mixtures thereof.

Such binding and/or structuring and/or stabilising agents can be beneficial for achieving very good form stability of the dairy product (such as fresh cheese) or dairy product analogue at elevated temperature, and to obtain a stable product that does not suffer from oil exudation or moisture syneresis. Preferably however the total level of stabilising or binding or structuring ingredients other than protein is less than 0.1 wt %, most preferably zero.

Preferably the above-mentioned optional ingredients are added after acidification of the protein source. If whey is separated off, the optional ingredients are preferably added after whey separation.

According to one embodiment the dairy product is prepared by a process that includes the steps of:
(a) acidifying an aqueous composition comprising a protein source and optionally fat, such as milk or milk analogue or cream or cream analogue or a combination thereof, using a culture comprising the exopolysaccharide producing lactic acid bacteria and optionally other acidifying cultures to cause coagulation;
(b) applying a heat treatment, optionally removing whey, and optionally incorporating further ingredients, in any order.
(c) filling the product in the final package.

Possibly, filling process and final package are aseptic.

A preferred process comprises whey removal in step (b), after the heat treatment.

The preferred aqueous composition of step (1) is milk or milk analogue or cream or cream analogue or combination thereof. The aqueous composition used in step (a) can for example be an ordinary milk or cream standardised to a particular protein and/or fat content according to the desired end product and the process to be applied. The milk can also be reconstituted milk from powdered milk. The milk or cream can include other materials e.g. buttermilk, skim milk, butterfat, vegetable fat, marine oil etc. The dairy analogue product may be based on vegetable fat and/or vegetable proteins. The milk or cream may have been pasteurised and/or treated at high temperature and/or homogenised.

The aqueous composition is acidified, by means of a starter culture comprising exopolysaccharide producing lactic acid bacteria, with optionally a small amount of rennet being included.

Coagulation is preferably caused to occur by the action of acid rather than the combined action of acid and heat; accordingly the acidified aqueous composition in which coagulation has occurred preferably has a pH of from 4.0 to 5.0, more preferably from 4.2 to 4.8.

Acidification and coagulation can be stopped by applying the said heat treatment according to step (b) for example above 58° C. for a period of 5 minutes.

Possibly, chemical acidification with food acids is partly used.

Optionally whey is removed, preferably by ultrafiltration (UF) or centrifuging in a separator.

The heat treatment according to step (b) is preferably carried out at a temperature of above 60° C., preferably 65-100° C., more preferably 70-80° C., most preferably 75-80° C.

It can further be beneficial to subject the curd to a homogenisation, e.g. by passage through a homogeniser. Homogenisation can be applied while the product is at elevated temperature. Preferably homogenisation takes place in a homogeniser operating at, for example, a pressure of at least 50 bar, preferably 75-500 bar, particularly 100-300 bar.

Suitable sterols for use in the invention include phytosterols, phytostanols and their corresponding esterified derivatives. Preferably the sterols are partly esterified or not esterified to a fatty acid.

Some specific examples include 5,7,22-cholestatrienol, 7-dehydrocholesterol, 22-dehydrocholesterol, 24-dehydrocholesterol, zymosterol, Δ⁷-cholesterol, 7-coprostenol, cholestanol, coprostanol, epicoprostanol, cerebrosterol, 22-α-oxycholesterol, 22-dihydroerogosterol, 7,24(28)-erogostadienol, campesterol, neospongosterol, 7-ergostenol, cerebisterol, corbisterol, stigmasterol, focosterol, α-spinasterol, sargasterol, 7-dehydrocryonasterol, poriferasterol, chondrillasterol, β-sitosterol, cryonasterol, (γ-sitosterol), 7-stigmasterol, 22-stigmatenol, dihydro-γ-sitosterol, β-sitostanol, 14-dehydroergosterol, 24(28)-dehydroergosterol, ergosterol, brassicasterol, 24-methylenecholesterol, ascosterol, episterol, fecosterol, 5-dihydroergosterol, and their mixtures. β-sitostanol, β-sitosterol, β-sitostanol ester, campesterol and brassicasterol are preferred examples, with β-sitosterol or β-sitostanol being especially preferred.

The amount of sterol to be included in the dairy product or analogue thereof will depend on the nature of the dairy product and its nutritional requirements, but technically the invention works best at high sterol to fat ratio

Generally the total product will contain up to 30% sterol, with a range of 0.001 to 10% being exemplary. A preferred range is from 0.05 to 5%, more preferably 0.05 to 2.5%.

Herbs and other materials comprising discrete particles which are to remain discernible as such in the end product are preferably incorporated late in the process, preferably just before the filling. If such discrete particles containing materials are to be included, it is for hygienic reasons particularly desired that the product after incorporation of such materials is pasteurised. If so desired materials may be put on the surface of the product, e.g. part or all of the product surface may be supplied with a layer of herbs, pieces of nuts etc.

Ingredients that need not remain discernible as such in the end product, e.g. salt or spices can be incorporated at an earlier stage of the process, but preferably such incorporation is done at a stage after the optional whey removal has taken place.

Products according to the invention can be blended with other food products. Therefore the invention also relates to food products comprising dairy products or dairy product analogues prepared according to the invention. As an example, an acidified milk based product according to the invention can be blended with other components to form a food product. The amount of the acidified product is preferably more than 5 wt %, for example from 5 to 95 wt %.

Preferred embodiments of the invention will now be described by way of example only. Further modification within the scope of the present invention will be apparent to the person skilled in the art.

### EXAMPLES

### Example 1

In this example a sour cream-type composition was prepared.

Example A is according to the invention. Example B and C are comparative examples.

| | | Example B | Example C |
|---|---|---|---|
| | Example A | (comparative) | (comparative) |
| Lipid phase | Oil + Sterols | Oil + Sterols | Oil |
| Fermentation | Lactobacillus | Lactobacillus | Lactobacillus |
| culture | Helveticus | Helveticus 7 | Helveticus 7 |
| | NCD0766 | Wiesby | Wiesby |
| | +eps +sterols | −eps +sterols | −eps −sterols |

The following ingredient composition was used.

| | |
|---|---|
| Wt % | ingredients |

Recipe with sterols

| | |
|---|---|
| 12.5 | Sterol mix |
| 12.5 | Vegetable fat blend |
| 10 | Skim milk powder |
| 5 | sucrose |
| 0.0075 | EDTA |
| Up to 100 | water |
| 100 | total |
| 25 | Vegetable fat blend |
| 10 | Skim milk powder |
| 5 | sucrose |
| 0.0075 | EDTA |
| Up to 100 | water |
| 100 | total |

Fermentation cultures

| | |
|---|---|
| EPS forming | Lactobacillus |
| | Helveticus NCDO766 |
| Not EPS forming | Lactobacillus |
| | Helveticus 7 Wiesby |

The sterol mix was a composition rich in beta sitosterol.

### Process

Skim milk powder was solved in water phase and stood overnight at 5° C. If present, the sterol mix was dissolved in the fat phase at 60° C. Sucrose, EDTA were added to the water phase comprising skim milk powder. The water phase was heated to a temperature of at most 60° C. The aqueous phase and fat phase were mixed in a Stephan™ pan. The mix was ultra turraxed for 2 min at 8000 rpm and pasteurised for 15 minutes at 72° C. The mix was then homogenised at about 10 bar and cooled to 37° C. At this temperature fermentation was done with the indicated culture to pH 5 in an incubator. The fermentation was stopped by pasteurisation for about 5 minutes at 75° C. The mixture was then homogenised at 100 bar and filled into tubs that were stored at 5° C.

A long tube (height 55 cm, diameter 2.4 cm) was filled with fermenting pre-mix and stored at 37° C. After the fermentation process, the amount of fat was determined in the middle and at the bottom of the tube (see figure). The bottom slice was located in the tube between 0-5.5 cm height, and the middle slice (22-27.5 cm) as measured from the bottom, and the slices weighted approximately 25 g. Ideally, fat content would have been taken at the top, but occasional coalescence in this type of experiment may result in the formation of a solid fat top layer, which would confuse the interpretation of the experiment.

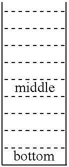

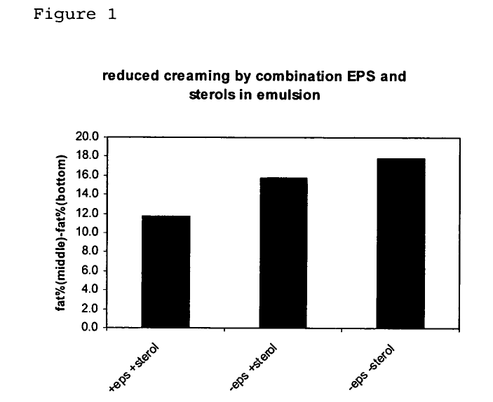

The difference in fat content is expressed in FIG. 1 (The fat phase includes sterols). It can be seen that the presence of both sterols and EPS helps to reduce creaming in the emulsion during fermentation. The average fat content in the product was 25%.

1. A method of preparing a dairy product or a dairy product analogue, the dairy product or dairy product analogue comprising sterols, which method comprises acid coagulating a protein source in the presence of a suitable acidifying culture capable of producing exopolysaccharides.

2. A method according to claim 1 wherein coagulation is followed by whey separation.

3. A method according to claim 1 wherein after acidification the product is homogenised.

4. A method according to claim 1 wherein the protein source is cheese milk, cream or a combination thereof.

5. A method according to claim 1 wherein the exopolysaccharide producing bacterium is selected from Lactobacillus delbrueckii supsp. bulgaricus 291 and Lactobacillus helveticus NCDO 766 and mixtures thereof.

6. A method according to claim 1 wherein the sterol is present in an amount of from 0.001 to 10 wt %.

7. A method according to claim 1 wherein the sterol is selected from β-sitostanol, β-sitosterol, β-sitostanol ester, campesterol or brassicasterol, or mixtures thereof.

8. A food product comprising a dairy product or dairy product analogue prepared according to claim 1.

9. Dairy product or dairy product analogue prepared according to the method of claim 1.

10. Use of a dairy product or dairy product analogue produced according to claim 1 in the manufacture of a food product.
